(19) United States
(12) Patent Application Publication
(10) Pub. No.: US 2010/0000153 A1
(43) Pub. Date: Jan. 7, 2010

(54) REMOTE MICRO-SCALE GTL PRODUCTS FOR USES IN OIL- AND GAS-FIELD AND PIPELINE APPLICATIONS

(75) Inventors: ANDREW KURKJIAN, Sugar Land, TX (US); STEPHEN C. LEVINESS, Tulsa, OK (US); KEITH JAMES MASSIE, ABERDEEN (GB); JOHN NIGHSWANDER, Houston, TX (US)

Correspondence Address: BAKER & MCKENZIE LLP, Pennzoil Place, South Tower, 711 Louisiana, Suite 3400, HOUSTON, TX, 77002-2716, US

(73) Assignee: KYROGEN USA, LLC, Houston, TX (US)

(21) Appl. No.: 12/168,520

(22) Filed: Jul. 7, 2008

(51) Int. Cl. C01B 3/32

(52) U.S. Cl. 48/127.3

(57) ABSTRACT

A method of operating one or more production facilities located at a remote natural gas source is provided including providing one or more micro-scale GTL systems to the remote NG source; supplying natural gas feedstock from the remote source to the micro-scale GTL systems; operating the micro-scale GTL systems to produce a product stream; and utilizing the product stream in the production facilities located at the remote natural gas source. Also provided is a method of operating one or more production facilities located at a remote NG source that includes supplying a product stream to a central processing unit within the remote location to produce a fuel or chemical product.

### FEDERALLY SPONSORED RESEARCH

Not applicable.

### REFERENCE TO MICROFICHE APPENDIX

Not applicable.

### FIELD OF THE INVENTION

This invention relates to use of micro-scale gas-to-liquid oxygenate and/or hydrocarbon products.

### BACKGROUND OF THE INVENTION

Oil and natural gas production facilities generally require processed fuel products, such as gasoline, diesel, processed (e.g. to remove free water, oil and/or condensate) and/or compressed natural gas (“CNG”) for power generation, drilling rig propulsion, and/or motor vehicle fleet engines. Such production facilities may utilize various synthetic fuels produced by any number of known processes for the same purposes, e.g., power generation from synthetic diesel fueled generators. Methanol, or other chemical products, are often commonly required for certain treatment operations, and can also be used as a fuel, fuel additive or for power generation. Certain production facilities, especially those producing very heavy hydrocarbon streams such as oil sands bitumen, may require significant quantities of light hydrocarbon streams, such as light distillates and/or naphthas, for use as diluents to allow acceptable flow characteristics in pipelines. Likewise, processed products, such as processed natural gas, may be used for power generation.

Oil and/or gas production facilities can be located in relatively-to-very remote geographical areas, often far from typical commercial fuel and/or chemical production and distribution systems. Even locations that are not geographically remote can be effectively remote when there is no infrastructure for oil or especially gas transportation and/or when required fuel and/or chemical products are not locally produced or readily delivered to the production facility.

As used herein the term “resource export remote” refers to gas fields that meet the typical meaning of a “stranded” gas field. Specifically, this term refers to those gas resources (e.g., gas fields, landfills) that are, in view of the size of the field, economically unavailable to potential gas markets. That is, the larger the gas resource the more distant it must be from potential markets to make the resource economically unavailable and resource export remote. For example, a very small gas field (e.g. producing less than about 500 thousand standard cubic feet per day (MSCFD) for about or less than 5 years) could generally be economically unavailable to transportation facilities or markets located as little as 5 miles away from the gas field because the field will not produce sufficient gas to justify construction of conventional pipeline/transportation systems. The exact value would, of course, depend strongly on the combination of both the current local natural gas wellhead price and the cost of the required infrastructure for the product gas gathering and transportation, in addition to the total size and flow rate of the gas resource. On the opposite end of the scale, extremely large gas fields may be economically available to markets located hundreds of miles away, again highly dependent on both gas price and cost of transportation infrastructure. In yet other instances, a large gas field could be resource export remote for a period of time, up to several years, while testing is conducted to determine if the size of the gas resource can justify either installing a gathering/transportation system or paying the tapping fee to connect into an existing transportation pipeline.

As used herein the term “fuel product import remote” refers to locations that are economically unavailable to liquid fuel production and delivery infrastructure (i.e., refineries and/or liquid (or processed gas) fuel distribution). That is, fuel product import remote locations refer to resources to which it is prohibitively or excessively expensive to deliver fuel products for use at the resource. Fuel product import remote locations generally include: (i) offshore locations, and (ii) geographically remote locations—such as, the Alaska North Slope, most parts of Siberia, and far east Russia, (Kamchatka and/or Sakalin). Determination of fuel product import remote further includes consideration of the volumes of fuel required for use at the resource as economies of scale may be achieved when larger volumes of fuel are required at the resource. When referred to herein, fuel product import remote locations include, but are not limited to: (i) gas fields with gas transportation infrastructure, including, for example, large offshore gas production units with substantial undersea pipeline capacities and large but geographically remote on-shore gas fields with pipelines to markets; (ii) gas condensate fields, and (iii) associated gas fields. Generally, these resources employ fuel products that can be manufactured from at least a portion of the gas that is produced from the resource.

As used herein the term “chemical product import remote” refers to a location that is sufficiently distant from infrastructure for the production and delivery of chemicals typically used at oil and/or gas resources that the delivered cost of these chemicals is much higher than the usual market rates. Chemicals used at such resources include methanol which is used for hydrate inhibition in gas production and transportation. The need for hydrate inhibition is highest in: (i) offshore installations with (deep) sub-sea gas pipelines, and (ii) colder climate onshore gas fields. However, methanol for hydrate inhibition may be useful in other gas fields in instances in which the gas is subjected to high pressure and low temperature. Because almost all methanol used in the U.S. and Canada is imported, any U.S. or Canadian resources significantly distant from import or distribution hubs would be chemical product import remote with respect to methanol.

As used herein the term “diluent import remote” means a location that is economically unavailable to infrastructure for the production and delivery of diluents, typically light distillate and naphtha. Diluents are typically used with heavy or waxy oil resources, and particularly those which produce extremely heavy oils, such as Alberta oil sands (bitumen) product. These products are often too viscous to meet transportation pipeline specifications, and must be diluted with lighter liquids in order to be accepted by the pipeline operator. An associated gas resource may be diluent import remote, as may be a gas resource located near oil resources at which a diluent may be used.

This potential usage of gas-to-liquid products, especially Fischer-Tropsch synthesis based products, is in contrast to the more common concept of producing liquid products from associated, or other, gas resources and then adding the product liquid to an existing (liquid) oil pipeline simply to transport the GTL products to market. Raw (not upgraded) FT products typically consist of at least 30%, and commonly over 50%, wax, which is a solid at ambient temperatures. Upgraded FT products are typically >50% distillate (diesel and/or jet fuel) and/or lube oil fractions. Raw GTL liquids have sufficiently high melting points that at high concentrations they would themselves be considered heavy or waxy (synthetic) crudes, and would be too viscous to meet transportation pipeline specifications, while upgraded FT products—although liquids—tend to be heavy enough that they would not function as acceptable heavy oil diluents. Monetization of, for example, associated gas by conversion to FT liquids is based on adding relatively low concentrations—typically less than 20-30%—of these products to planned or existing crude oil transportation facilities such as pipelines or tankers where the crude oil serves as a diluent for the GTL products. Such a scenario is impractical when dealing with heavy and/or waxy crudes that require dilation to meet transportation specifications; addition of conventional FT liquid products will degrade rather than improve flow properties.

When used without any of these modifiers, the term “remote” as used herein collectively refers to resource export remote, fuel product import remote, chemical product import remote and diluent import remote.

Methanol is a very common and effective additive for inhibition of methane (or other hydrocarbon) hydrate formation in and dehydration of (removal of water content from) natural gas, particularly in natural gas production, processing, and pipeline facilities/applications. Large amounts of methanol are typically employed in many North American (and particularly U.S. and Canadian) gas producing areas, including both on- and off-shore facilities, often year round, but especially during the winter months when colder temperatures result in increased chance of hydrate and/or water ice formation. Similar applications exist throughout oil and gas producing regions of the entire off-shore, and temperate and polar on-shore areas of the world. Many off-shore gas production facilities utilize high pressure, underwater (sea floor) pipelines to transfer the produced natural gas to on-shore processing facilities. Even in tropical latitudes ocean floor sea water temperatures can be low enough to allow methane (or other hydrocarbon gas) hydrate formation in the presence of water. Such hydrate formation can restrict or plug the undersea pipeline, causing production outages (loss of revenue) and requiring sometimes extensive treatments to restore production/flow.

Methanol is a well-known freeze point depressant (or, anti-freeze) for water, and is commonly employed as a windshield washer fluid or de-icer. Methanol can also be used in generally low temperature acid gas (e.g., CO₂, H₂S) removal and/or dehydration processes, such as the Rectisol® or IFPEXOL® process, which can also be effectively employed for natural gas upgrading and/or downstream processing. Finally, methanol has also been employed as an oil or gas field corrosion inhibitor depending on gas composition and equipment materials of construction.

Methanol can be converted to a large number of other products, including for example formaldehyde, acetic acid, and methyl methacrylate, regardless of the method of methanol production (for example by conventional synthesis gas (“syngas”) routes or by direct methane oxidation to methanol). Of particular interest for remote, but particularly for fuel product import remote oil and gas field operations are the production of diesel substitute fuels such as dimethyl ether (“DME”), which is produced by methanol dehydration, and/or synthetic gasoline fuels produced by methanol to gasoline (“MTG”) or DME to gasoline processes. Such processes are described in U.S. Pat. Nos. 7,199,278; 7,166,757; 7,132,580; 7,078,578; 6,852,897; 6,800,665; 6,768,034; 6,740,783; 6,710,218; 6,632,971; 6,613,951; 6,608,114; 6,534,692; 6,486,219; 6,444,869; 6,399,844; 6,372,949; 6,303,839; 6,191,175; 6,166,282; 6,121,503; 6,049,017; 6,045,688; 5,990,369; 5,952,538; 5,750,799; 5,744,680; 5,723,401; 5,714,662; 5,602,289; 5,573,990; 5,545,791; 5,491,273; 5,367,100; 5,316,627; 5,238,898; 5,233,117; 5,191,142; 5,191,141; 5,177,279; 5,167,937; 5,130,101; 5,095,163; 5,095,159; 5,047,070; 5,045,287; 5,041,690; 5,028,400; 4,985,203; 4,981,491; 4,935,568; 4,929,780; 4,899,002; 4,898,717; 4,873,390; 4,857,667; 4,849,575; 4,831,195; 4,814,536; 4,814,535; 4,788,377; 4,788,369; 4,788,365; 4,788,042; 4,689,205; 4,684,757; 4,628,135; 4,590,320; 4,579,999; 4,560,807; 4,550,217; 4,513,160; 4,496,786; 4,476,338; 4,449,961; 4,410,751; 4,404,414; 4,393,265; 4,337,336; 4,058,576; 4,052,479; 4,035,430; 4,025,576; 4,025,575; 3,998,898; 3,972,958; 2,793,241, the disclosures of which are incorporated herein in their entirety by reference for all purposes.

Methanol can also be employed to generate electrical power that may be used for many purposes including for example, vehicle propulsion using fuel cells, both in conventional hydrogen (“PEM”) fuel cells following methanol reforming and water-gas-shift, and in direct methanol fuel cells (“DMFC”). Both processes require water or steam co-feed, and obviate the need for extremely high purity (i.e., low water content) methanol feed. Methanol can also be used directly as a fuel for internal combustion engines (“ICE”), both in relatively pure form (i.e., M100) or in blends with conventional or synthetic gasoline (i.e., M15 or M85), and/or as a general combustion fuel for cooking, heating, and/or power generation. Blending small amounts of relatively impure (water containing) methanol into conventional or synthetic gasoline (i. e. production of M15) has the added benefit that the water contained in the raw methanol will typically separate out as an aqueous phase, which can be physically removed from the methanol-gasoline blend.

Mixed higher (C₂₊) alcohols, including ethanol, propanol, butanol, pentanol, etc. can also be used an octane boosting additive for conventional or synthetic gasoline. Processes for the production of methanol and/or these higher alcohols are disclosed in U.S. Pat. Nos. 7,288,689; 7,255,845; 7,144,923; 7,067,558; 7,033,972; 7,015,255; 7,014,835; 6,969,505; 6,894,080; 6,881,759; 6,875,794; 6,800,665; 6,608,114; 6,486,218; 6,433,029; 6,387,963; 6,300,380; 6,255,357; 6,218,439; 6,191,175; 6,069,180; 5,908,963; 5,767,039; 5,753,716; 5,627,295; 5,530,168; 5,512,599; 5,508,246; 5,424,335; 5,287,570; 5,284,878; 5,262,443; 5,219,891; 5,218,003; 5,216,034; 5,179,129; 5,169,869; 5,096,688; 5,063,250; 4,910,227; 4,886,651; 4,876,286; 4,873,267; 4,868,221; 4,812,433; 4,791,141; 4,780,481; 4,766,155; 4,766,154; 4,725,626; 4,666,944; 4,628,066; 4,609,678; 4,540,713; 4,537,909; 4,521,540; 4,521,248; 4,520,216; 4,507,403; 4,481,305; 4,481,012; 4,477,594; 4,476,250; 4,460,378; 4,455,394; 4,444,909; 4,417,000; 4,238,403; 3,950,369; 3,940,428; and 3,939,191, the disclosures of which are incorporated herein in their entirety by reference for all purposes.

Similarly, synthetic gasoline and diesel fuel can be produced from natural gas by a number of different processes, such as by upgrading synthetic crude oil (“syncrude”) produced in a gas-to-liquid (“GTL”) process, such as a Fischer-Tropsch (“FT”) synthesis utilizing syngas. Syngas generation processes to produce syngas which may be used in oxygenate and/or Fischer-Tropsch synthesis processes are disclosed in U.S. Pat. Nos. 7,335,346; 7,332,147; 7,323,497; 7,297,169; 7,262,334; 7,261,751; 7,255,840; 7,250,151; 7,241,401; 7,232,532; 7,214,331; 7,166,268; 7,105,147; 7,094,363; 7,090,826; 7,087,651; 7,087,192; 7,074,347; 7,067,560; 7,056,488; 7,037,485; 7,033,569; 6,984,371; 6,958,310; 6,953,488; 6,793,700; 6,761,838; 6,749,828; 6,730,285; 6,702,960; 6,695,983; 6,693,060; 6,680,006; 6,673,270; 6,669,744; 6,635,191; 6,609,562; 6,607,678; 6,534,551; 6,527,980; 6,525,104; 6,492,290; 6,489,370; 6,488,907; 6,475,409; 6,461,539; 6,458,334; 6,455,597; 6,409,940; 6,402,989; 6,402,988; 6,387,843; 6,376,423; 6,375,916; 6,355,219; 6,340,437; 6,338,833; 6,312,660; 6,312,658; 6,254,807; 6,224,789; 6,214,066; 6,174,460; 6,155,039; 6,153,163; 6,143,203; 6,143,202; 6,114,400; 6,085,512; 6,077,323; 6,048,472; 6,007,742; 5,993,761; 5,989,457; 5,980,840; 5,980,782; 5,980,596; 5,958,364; 5,935,489; 5,931,978; 5,883,138; 5,855,815; 5,753,143; 5,720,901; 5,714,132; 5,658,497; 5,654,491; 5,653,916; 5,653,774; 5,648,582; 5,637,259; 5,591,238; 5,554,351; 5,500,149; 5,431,855; 5,310,506; 5,252,609; 5,149,464; 5,068,057; 4,985,230; 4,861,351; 4,836,831; 4,767,569; 4,681,701; 4,048,250; 3,573,224; 3,429,678; 3,250,601; 2,942,958; 2,772,149; 2,765,222; 2,684,895; 2,683,152; 2,676,156; 2,665,199; 2,662,004; 2,638,452; 2,635,952; 2,632,690; 2,622,089; 2,543,791; 2,541,657; 2,529,630; 2,522,468; 2,520,925, the disclosures of which are incorporated herein by reference in their entirety for all purposes.

Fischer-Tropsch synthesis processes for the production of synthetic crude are known in the art, including for example, in U.S. Pat. Nos. 7,294,253; 7,262,225; 7,241,815; 7,217,741; 7,115,670; 7,109,248; 7,084,180; 7,067,561; 7,067,560; 7,067,559; 7,045,554; 7,045,486; 7,037,947; 7,011,760; 7,001,927; 6,982,287; 6,977,237; 6,942,839; 6,964,398; 6,946,493; 6,872,753; 6,864,293; 6,809,122; 6,797,243; 6,784,212; 6,750,258; 6,730,708; 6,716,887; 6,638,889; 6,558,634; 6,512,018; 6,491,880; 6,479,557; 6,465,530; 6,451,864; 6,403,660; 6,353,035; 6,319,872; 6,344,491; 6,284,807; 6,262,131; 6,235,798; 6,214,890; 6,211,255; 6,180,684; 6,147,126; 6,121,333; 6,103,773; 6,075,061; 6,060,524; 6,043,288; 5,981,608; 5,958,986; 5,905,094; 5,869,541; 5,844,005; 5,817,701; 5,783,607; 5,776,988; 5,770,629; 5,756,419; 5,422,375; 5,348,982; 5,227,407; 5,169,869; 5,135,958; 5,116,879; 5,037,856; 4,978,689; 4,906,671; 4,788,222; 4,686,238; 4,686,313; 4,652,587; 4,640,766; 4,613,624; 4,605,680; 4,605,679; 4,605,676; 4,599,481; 4,594,172; 4,585,798; 4,523,047; 4,492,774; 4,423,265; 4,418,155; 4,399,234; 4,385,193; 4,157,338; 4,088,671; 4,086,262; 4,042,614; 2,957,902; 2,818,418; 2,805,239; and 2,771,481; the disclosures of which are incorporated in their entirety herein by reference for all purposes.

As used herein, the term “product upgrading” refers to any subsequent processing or treatment of the synthetic crude to produce an intermediate or end use product, including for example, lubricant basestock, lubricants, greases, middle distillate fuels, diesel, linear alkylbenzenes, aviation and jet fuels, gasoline, and other chemicals, i.e., normal- and iso-paraffinic solvents. Such product upgrading methods are disclosed for example in U.S. Pat. Nos. 7,332,072; 7,326,331; 7,320,748; 7,300,565; 7,294,253; 7,288,182; 7,285,206; 7,282,139; 7,282,137; 7,271,304; 7,252,754; 7,238,277; 7,235,172; 7,232,515; 7,198,710; 7,195,706; 7,179,364; 7,156,978; 7,138,047; 7,132,042; 7,125,818; 7,074,320; 7,053,254; 7,033,552; 7,018,525; 6,962,651; 6,939,999; 6,900,366; 6,841,711; 6,833,064; 6,824,574; 6,822,131; 6,797,154; 6,787,022; 6,784,329; 6,768,037; 6,755,961; 6,743,962; 6,727,399; 6,723,889; 6,703,535; 6,702,937; 6,700,027; 6,693,138; 6,686,511; 6,669,743; 6,663,768; 6,635,681; 6,607,568; 6,605,206; 6,602,840; 6,583,186; 6,544,407; 6,515,034; 6,515,032; 6,475,960; 6,458,265; 6,420,618; 6,383,366; 6,375,830; 6,332,974; 6,309,432; 6,296,757; 6,190,532; 6,180,842; 6,179,994; 6,162,956; 6,096,940; 6,025,305; 5,993,644; 5,976,351; 5,888,376; 5,882,505; 5,766,274; 5,750,819; 5,378,348; 5,362,378; 5,246,566; 5,135,638; 4,995,962; 4,975,177; 4,943,672; 4,919,786; 4,520,215; 4,513,156; 4,500,417; 4,385,193; 4,234,412; 4,126,644; 4,071,574; 4,059,648; 4,044,064; 4,041,096; 4,041,095; 3,329,602; 3,268,436; 3,255,101; 3,239,455; 3,224,956; 3,193,490; 3,044,949; 3,001,857; 2,847,358; 2,761,871; 2,752,382; and 2,741,649, the disclosures of which are incorporated by reference herein in their entirety for all purposes.

Alternatively, synthetic gasoline and diesel fuel can be produced from any type of oxidative or non-oxidative (direct) methane coupling, typically producing methanol, or mixtures of ethylene (and/or higher olefins) and ethane (and/or higher paraffins), or aromatics. Such methanol and/or olefins may then be polymerized to form gasoline or diesel range products, while the product ethane and/or higher paraffins can be dehydrogenated to olefins and then polymerized. Aromatics can be employed as an octane boosting additive for conventional or synthetic gasoline. Methods of direct methane conversion are disclosed in U.S. Pat. Nos. 7,291,321; 7,250,543; 7,176,342; 7,033,551; 7,022,888; 6,924,401; 6,821,500; 6,596,912; 6,576,803; 6,552,243; 6,518,476; 6,500,313; RE37,853; 6,414,195; 6,403,523; 6,380,444; 6,375,832; 6,326,407; 6,294,701; 6,159,432; 6,087,545; 6,028,228; 5,959,170; 5,936,135; 5,935,293; 5,877,387; 5,849,973; 5,817,904; 5,763,722; 5,750,821; 5,749,937; 5,736,107; 5,712,217; RE35,633; RE35,632; 5,670,442; 5,625,107; 5,599,510; 5,585,515; 5,527,978; 5,430,219; 5,414,157; 5,406,017; 5,345,011; 5,345,010; 5,336,825; 5,328,575; 5,321,188; 5,321,187; 5,321,185; 5,316,995; 5,312,795; 5,306,683; 5,276,237; 5,260,497; 5,254,778; 5,246,550; 5,245,124; 5,245,109; 5,238,898; 5,223,471; 5,220,080; 5,214,226; 5,212,139; 5,204,308; 5,198,596; 5,196,634; 5,177,294; 5,157,189; 5,157,188; 5,146,027; 5,132,482; 5,132,481; 5,130,286; 5,118,898; 5,118,654; 5,113,032; 5,105,053; 5,105,046; 5,105,044; 5,095,161; 5,093,542; 5,082,816; 5,081,324; 5,077,446; 5,073,657; 5,073,656; 5,071,815; 5,068,486; 5,068,215; 5,066,629; 5,061,670; 5,053,578; 5,051,390; 5,041,405; 5,028,577; 5,026,947; 5,026,945; 5,024,984; 5,015,799; 5,015,461; 5,012,028; 5,004,856; 4,997,802; 4,996,382; 4,992,409; 4,988,660; 4,982,041; 4,968,655; 4,962,261; 4,952,547; 4,939,312; 4,939,311; 4,939,310; 4,929,797; 4,929,787; 4,921,685; 4,918,257; 4,918,249; 4,914,252; 4,886,931; 4,849,571; 4,827,071; 4,822,944; 4,814,539; 4,808,563; 4,801,762; 4,795,849; 4,795,848; 4,795,842; 4,794,100; 4,791,079; 4,788,372; 4,783,572; 4,769,507; 4,754,095; 4,754,094; 4,754,093; 4,754,091; 4,751,336; 4,751,055; 4,743,575; 4,734,537; 4,728,636; 4,727,212; 4,727,211; 4,727,207; 4,727,205; 4,721,828; 4,704,496; 4,704,493; 4,704,488; 4,704,487; 4,695,668; 4,678,862; 4,672,144; 4,670,619; 4,665,261; 4,665,260; 4,665,259; 4,658,077; 4,658,076; 4,654,460; 4,634,800; 4,620,057; 4,613,718; 4,593,139; 4,568,785; 4,560,821; 4,554,395; 4,547,611; 4,547,608; 4,544,787; 4,544,786; 4,544,785; 4,544,784; 4,523,050; 4,523,049; 4,517,398; 4,499,324; 4,499,323; 4,499,322; 4,495,374; 4,489,215; 4,465,893; 4,450,310; 4,444,984; 4,443,649; 4,443,648; 4,443,647; 4,443,646; 4,443,645; 4,443,644, the disclosures of which are incorporated herein in their entirety for all purposes.

In other instances, synthetic gasoline and/or diesel fuel can be produced from methane pyrolysis to acetylene followed by hydrogenation to ethylene and polymerization of the ethylene product. Synthetic gasoline and/or diesel can also be produced by processes based on bromine-, chlorine-, and/or sulfur-containing intermediates. Various aspects of the foregoing processes are described in U.S. Pat. Nos. 6,130,260; 6,323,247; 6,433,235; 6,602,920; 7,045,670; 7,119,240; 7,183,451; 7,208,647; 7,348,464; 7,244,867; 7,161,050; 7,148,390; 7,019,182; 6,713,655; 6,525,230; 6,486,368; 6,472,572; 6,465,699; 6,465,696; 6,462,243; 6,403,840; 4,199,533; 4,467,127; 4,513,092; 7,282,603; and 6,380,444, the disclosures of which are incorporated in their entirety herein by reference for all purposes.

As late as 1998 less than 10% of the methanol consumed in the U.S. and Canada was imported from other areas; by 2007 more than 80% was imported from lower cost feedstock production plants located in other continents. Delivery of methanol to many oil and/or gas production facilities, especially those in chemical product import remote locations, can be difficult and expensive. In addition, nearly all of the methanol imported into the U.S. and Canada is of very high purity (>99%), consistent with its use as a raw material for production of chemicals, such as formaldehyde, acetic acid, methyl-tert-butyl-ether (“MTBE”), or methyl methacrylate. Such high purity is not required for most oil and gas production applications such as hydrate or corrosion inhibition and/or dehydration, or for use in the MTG process or dehydration to DME, or direct combustion in for power or heat generation. The general lack of availability of lower purity grades of methanol, as well as the logistical difficulties in transporting methanol to chemical product import remote oil and/or gas production facilities, significantly increases the cost of using methanol for these purposes.

Pure methanol has a relatively high vapor pressure, and can be considered a flammability hazard in many locations, especially oil and/or gas production facilities. It is currently common for high purity methanol, purchased for methane hydrate inhibition applications, to be immediately diluted with water in order to lower the vapor pressure, and thereby reduce flammability. Purchase of high purity methanol for on-site oil and/or gas production facility applications, required because lower purity methanol is not available, only serves to significantly increase the cost of performing necessary functions, i.e., hydrate and corrosion inhibition. Methanol also has other oil and/or gas field applications, including use as a constituent of fracturing gels and as a dehydrating agent employed during pipeline pigging operations; such uses generally require smaller volumes than use as a hydrate and corrosion inhibitor.

Similarly, although oil and/or natural gas are the feedstocks employed in producing usable engine fuels such as gasoline and diesel, these feedstocks—especially oil—generally must be shipped, trucked or pipelined to refineries for conversion into fuels or other upgraded products. The produced fuel must then be shipped back to the oil and/or gas production facilities for use at the oil and/or gas production facility, often resulting in both high costs and logistical difficulties. Natural gas is a partial exception, as it can be directly employed in power generation (in internal combustion engine or gas turbine driven generators), and as a motor vehicle fuel (typically as CNG) given adequate investment in CNG storage and distribution systems, as well as motor vehicle engine modifications to handle CNG.

An increasing percentage of the world's liquid hydrocarbons consist of heavy and very heavy crude oils and related products, such as bitumen produced from oil or tar sands, as well as very paraffinic crude oils. In many locations, particularly in western Canada, and more particularly in northern Alberta, as well as in many offshore locations, lighter products, typically light distillates and naphtha, are employed as diluents to improve the flow characteristics of these heavy oils. Solely for use as diluents, light distillates and/or naphtha are often imported to the oil production facility at significant cost. While methanol can also be employed as a heavy oil diluent, this is not commonly practiced to date because methanol can cause a number of detrimental effects during downstream processing of the primary hydrocarbon fluid. Such detrimental effects are mainly associated with corrosion in the refinery distillation towers, and/or adverse effects on bacterial populations in waste water treatment plants. However these negative effects can be offset by the positive benefits of improved flow characteristics for very heavy crude oil, and methanol should be considered as a potential diluent for such applications, especially when the possibility of producing methanol at the diluent import remote site exists; current applications of methanol as a diluent are significantly limited due to the difficulty of supplying sufficient methanol at the required location at a reasonable cost.

A more cost effective source of methanol and/or gasoline/diesel/other fuels for use in oil and/or gas production facilities located more proximally to the oil and/or natural gas production facility is needed.

### SUMMARY OF THE INVENTION

A first preferred embodiment of the invention provides a method of operating one or more production facilities located at a remote NG source, the method comprising the steps of: (1)providing one or more micro-scale GTL systems to the remote NG source; (2) supplying NG feedstock from the remote NG source to the one or more micro-scale GTL systems; (3) operating the one or more micro-scale GTL systems to produce a product stream; and (4) utilizing the product stream in the one or more production facilities located at the remote NG source. In some embodiments, the NG feedstock is a slipstream from an oil and/or natural gas wellhead. In some embodiments, the remote NG source is located at a chemical product import remote location.

In some embodiments of the inventive method, the product stream comprises methanol. In some of such embodiment, the methanol contains at least about 10% water.

In other embodiments, the inventive method further comprises the step of inhibiting hydrate formation within the one or more production facilities by injecting the methanol into the wellhead, one or more gathering lines, one or more transmission pipelines, or one or more sub-sea gas pipelines. In yet other embodiments, the inventive method further comprises the step of dehydrating a low quality natural gas stream by utilizing the methanol product in a natural gas dehydration process. In yet other embodiments, the inventive method further comprises the step of removing acid gas from a low quality natural gas stream by utilizing the methanol product in an acid gas removal process.

The method of claim 3 further comprising shipping the methanol product stream to a non-remote location; and purifying the methanol product stream to a chemical grade methanol product at the non-remote location.

In certain embodiments, the step of utilizing the product stream in the one or more production facilities located at the remote NG source comprises diluting a heavy hydrocarbon stream by injecting the methanol into the heavy hydrocarbon stream. In certain such embodiments of the inventive process, the heavy hydrocarbon stream is selected from the group of a waxy Fischer-Tropsch product, heavy oil produced from the one or more production facilities, and combinations thereof.

In some embodiments of the invention, the remote NG source is located at a fuel product import remote location. In certain such embodiments, the product stream includes methanol and wherein the step of utilizing the product stream comprises utilizing the methanol as an internal combustion engine fuel. In certain embodiments, the methanol is used either in substantially pure form or blended with conventional or synthetic gasoline prior to the utilizing as an internal combustion fuel. In other embodiments, the method further includes the step of converting the methanol to a fuel product stream comprising synthetic gasoline.

In some embodiments of the inventive method, the step of utilizing the product stream comprises utilizing the methanol as a feedstock for production of hydrogen to generate electrical power with a proton exchange membrane (PEM) fuel cell, to generate electrical power in a direct methanol fuel cell, or a combination thereof.

In some embodiments of the inventive method, the step of utilizing the product stream comprises utilizing the methanol as a freeze-point depressant.

In certain embodiments of the inventive method, the product stream comprises dimethyl ether. In certain such embodiments, the step of utilizing the product stream comprises utilizing the dimethyl ether as a substitute diesel fuel, an LPG fuel substitute, or a combination thereof. In some embodiments, the method further includes the step of converting the dimethyl ether to a fuel product stream comprising synthetic gasoline.

In certain embodiments of the inventive method, the product stream includes mixed higher alcohols and wherein the step of utilizing the product stream comprises utilizing the mixed higher alcohols in substantially pure form or blended with conventional or synthetic gasoline as an internal combustion fuel. In yet other embodiments of the inventive method, the product stream is a Fischer-Tropsch derived hydrocarbon liquid.

A second preferred embodiment of the invention provides a method of operating one or more production facilities located at a remote NG source comprising the steps of: (1) providing one or more micro-scale GTL systems; (2) supplying NG feedstock from the remote NG source to the one or more micro-scale GTL systems; (3) operating the one or more micro-scale GTL systems to produce a product stream; and (4) supplying the product stream to a central processing unit within the remote location to produce a fuel product. In some embodiments of such inventive method, the product stream is synthetic crude oil. In certain such embodiments of the method, the synthetic crude oil is produced in a Fischer-Tropsch process. Certain embodiments of the method further include utilizing the fuel product as a fuel at the one or more production facilities. In some embodiments, the fuel product comprises synthetic diesel fuel.

A third preferred embodiment of the invention provides a method of operating one or more production facilities located at a remote NG source, the method comprising the steps of: (1) providing one or more micro-scale GTL systems; (2) supplying NG feedstock from the remote NG source to the one or more micro-scale GTL systems; (3) operating the one or more micro-scale GTL systems to produce a product stream, wherein at least part of the product stream comprises a light distillate, naphtha stream, or combination thereof; and (4) utilizing the product stream in the one or more production facilities located at the remote NG source. In some such embodiments, the step of utilizing the product stream comprises diluting a heavy hydrocarbon stream. In certain embodiments, the heavy hydrocarbon stream is selected from the group of a waxy Fischer-Tropsch product, heavy oil produced from the one or more production facilities, and combinations thereof. In yet other embodiments, the heavy hydrocarbon stream comprises bitumen produced from oil or tar sands, bitumen derived products produced from oil or tar sands, or combinations thereof.

In some embodiments of the invention method, the micro-scale GTL systems are sized to fit within normal truck bed shipping size constraints and have a total weight of less than about 20 tons.

### DETAILED DESCRIPTION OF EMBODIMENTS OF THE INVENTION

As used herein in connection with embodiments of the invention, the terms “natural gas” and “NG” are used to refer to compositions comprising natural gas, methane, or combinations thereof. The terms “natural gas” and “NG” are used to refer to such compositions irrespective of the source. Thus, the terms “natural gas source,” “natural gas resource,” “natural gas well,” “natural gas field,” “NG source,” “NG resource,” “NG field,” and “NG well” refer to any source of natural gas and/or methane including by way of example but not limitation, natural gas wells, oil or crude wells that produce associated gas, shale gas wells, gas condensate wells, landfill gas (“LFG”) sources, coal bed methane (“CBM”) wells, and gas hydrate deposits.

The micro-scale gas-to-liquids process entails small, i.e., about 500 thousand standard cubic feet per day (MSCFD) NG feed rate, mass-produced, portable chemical processing units that convert stranded NG into more easily transported hydrocarbon liquid products at or very close to the production site (i.e., wellhead). Such hydrocarbon liquid products include methanol, dimethyl ether, mixed higher alcohols (ethanol, propanol, butanol, etc.), and/or their derivative products, including for example, MTBE, gasoline, and various hydrocarbons made by Fischer-Tropsch synthesis, and/or any other natural gas to hydrocarbon conversion process. Methods of producing all of these products are known in the art.

A recently constructed commercial conventional FT based GTL plant (Sasol “Oryx”, in Qatar) cost in the range of about $950 million for approximately 34,000 bbl/d FT liquid products, or about $28,000 per bbl/d hydrocarbon liquid product capacity. More recently, engineering, procurement, and construction (“EPC”) costs have increased such that currently forecasted GTL capital costs for plants to be constructed in the near future are in the range of $50,000 per bbl/d hydrocarbon liquid product for similarly sized conventional plants. As plant size is increased from S₁ to S₂, the ratio of costs increases nonlinearly, i.e., by some power other than 1. For example, consider two conventional facilities having different capacities, S₁ and S₂. The cost of the second facility (C₂) may be determined using a “scale factor” and the cost of the first facility (C₁), according to the formula, C₂=C₁*(S₂/S₁)ⁿ, where “n” is the scale factor. For n<1, costs rise at less than the ratio of plant size/capacity, so unit cost decreases yielding what is referred to as “economies of scale”. At a conventional plant scale factor of 0.6 these cost projections suggest that a 50-100 bbl/d hydrocarbon liquid product train would cost in the range of $19-29 million (at $28,000 per bbl/d hydrocarbon liquid product for the larger, conventional unit) to $34-51 million (at $50,000 per bbl/d hydrocarbon liquid product). Using the more recent specific capital cost prediction of $50,000 per bbl/d hydrocarbon liquid product capacity, and assuming a $50/bbl product price, the ratio of plant capital cost to total plant yearly revenue would vary from about 3.0 for a 34,000 bbl/d hydrocarbon liquid product plant to 31 for a 100 bbl/d hydrocarbon liquid product plant and 40 for a 50 bbl/d hydrocarbon liquid product plant. Even with zero costs for operating and maintenance (i.e., all revenue is profit) the time to pay back initial investment on such micro-scale plants is longer than the typical plant lifespan of 20-30 years. With the same $50/bbl product value assumption, actual total yearly revenues for these micro-scale 50-100 bbl/d hydrocarbon liquid product plants would range from about $850,000 to $1,600,000.

The large (14,000 to 45,000 bbl/d) methanol based GTL plants that have recently been constructed (e.g. completed in 2005-2006) have ranged in specific cost from about $90,000 to $180,000 per metric ton per day methanol capacity. These plants were largely completed before the recent large escalation in engineering, procurement and construction (EPC) costs occurred. Taking $100,000 per metric ton/day at 20,000 bbl/d methanol capacity, a normal scale factor of 0.6 would predict a specific cost of $10-15 million for a micro-scale methanol GTL plant producing 100-200 bbl/d methanol. The most recent small methanol plant that has been constructed (a Metaprocess plant for Novatec in Russia, 2007) reportedly cost about $10 million for approximately 250 bbl/d methanol capacity, consistent with a scale factor of about 0.7. Assuming a methanol product value of $1.00 per gallon ($42/bbl) actual total yearly revenues for these micro-scale 100-200 bbl/d methanol plants would range from about $1,500,000 to $3,000,000, while that from a $280 million capital 22,000 bbl/d conventional plant would be about $320 million. The ratio of plant capital cost divided by yearly revenue would therefore range from 0.875 for a large plant to 5-6 for a micro-scale plant, or by about a factor of 5.5 to 7.0. This is somewhat better than the factor of 10 calculated for FT based plants above, although it does not include more recent EPC cost increases but still suggests it would be difficult to achieve any return on investment (pay back the initial plant capital costs), even with very low or zero operating costs.

Thus, to achieve economic feasibility, plant capital investment costs for such micro-scale GTL plants must be significantly lower than the values predicted from large plant configurations, approaching a factor of 5-10 (or more) times lower, and annual total operating and maintenance costs should be much lower than the relatively small total annual revenue stream. Similar arguments are proposed in US patent application 20070208090 for off-shore GTL facilities that are more than 2 orders of magnitude larger than those considered here, in the range of 3,000 metric tons per day (ca. 25,000 bbl/d) product FT liquids, methanol, and/or dimethyl ether.

To achieve these economic targets, certain changes to conventional GTL plants are required. On the capital cost side, the process may be simplified, with the number of unit operations minimized. The number of vessels, instruments, and rotating equipment should be minimized. Plants are preferably not individually designed and engineered, but rather are engineered as a small number of standard designs that may be mass produced. The units may be shop fabricated, modular, and fit within normal truck bed shipping size constraints, e.g., 8 ft.×10 ft.×40 ft., and less than about 20 tons total weight. Alternatively, a single processing unit may be shop fabricated in more than one module, depending on targeted capacity. While the single standard shipping container size is an important consideration for ease in transportation, technology specific requirements may require modifications. Synthesis reactor size and/or geometry requirements may, for example, require a second, taller structure, in order to accommodate a reactor height larger than 8-10 feet, that would be shipped as a separate module and connected to the primary module at the NG production site. Similarly, equipment availability and/or cost might require certain process units, especially utilities, be located on a separate module from the main process units.

For the very exothermic syngas generation and FT/oxygenate synthesis as well as various oxidative coupling processes, heat exchanger size may be minimized, utilizing, for example, advanced finned tube designs. In some instances, utilities that are required (typically electrical power and boiler feed water/steam systems) may be applied as widely as possible, minimizing the number of different utilities included in the plant package.

Operating costs may also be minimized. In some instances, the plants may be highly, if not completely, automated. In other instances, the automated control systems may be capable of remote monitoring and control. In some instances, feed costs may be minimized, by use, for example, of stranded, flared/associated and/or non-pipeline standard (sub-quality) natural gas, most types of coal, and/or waste-stream biomass (including but not limited to, poultry litter, sawmill wastes, agricultural residues, (Kraft paper process) black liquor, municipal solid waste). These latter, non-NG feedstock sources, would typically require alternative synthesis gas manufacturing processes, such as gasification, a number of which are known in the art.

Maintenance frequency and costs may also be minimized by judicious equipment selection and process design and layout. In some instances, connections are welded (to avoid leaks associated with gaskets and fittings) except where maintenance constraints dictate flanges or other non-welded connections. Small-scale materials of construction considerations may result in “alloying up” to FeCr (or higher) alloys, compared to the more common large plant carbon steels.

Although raw (i.e., unpurified) methanol can be effectively and economically produced in micro-scale GTL units using known technologies, product purification is more challenging. Methanol synthesis plants producing high purity (i.e., chemical grade) methanol typically employ 2 or 3 relatively large distillation columns in order to separate product water, which is 10-25% by weight of the raw product, and other oxygenate and/or hydrocarbon byproducts (e.g., fusel oil), which are typically <2,000-5,000 ppm by weight from the raw methanol product. Addition of a full, chemical grade methanol purification train to each individual micro-scale GTL unit is, with currently known technologies, relatively prohibitive in terms of cost and equipment size. One small distillation column that could readily be accommodated in a micro-GTL unit is generally sufficient to achieve 95-98% methanol purity. At the same time, the use of a single small column would recover the majority of the product water for recycle to the synthesis gas generation process as feed steam system boiler feed water (“BFW”).

Higher purity methanol product can be cost effectively produced by shipping (e.g., trucking) the 95-98% methanol purity product from a number of individual methanol production units in a given geographical area to a larger (e.g., about 1,000 bbl/d or more) central distillation and/or processing facility, after which a chemical grade methanol product (about 99+% methanol purity) could be shipped to standard methanol storage and distribution centers. It would be desirable and economic if a market and/or other type of outlet for lower purity methanol closer to the actual locations of oil and/or NG production existed. Therefore, in some embodiments, lower purity methanol produced at or near natural gas (or other relatively low cost hydrocarbon) production and/or gathering facilities is used for methane hydrate inhibition and/or natural gas dehydration in the same or other natural gas production, gathering, or pipeline applications, ideally in at least somewhat close proximity to each other. In such embodiments, the logistical and economic problems associated with the current methods of methanol acquisition for methane hydrate inhibition are alleviated. Micro-scale GTL produced methanol may also be used as: (1) make-up solvent for acid gas (CO₂, H₂S, etc) removal and/or dehydration systems (such as the Rectisol® or IFPEXOL® process) for low quality natural gas upgrading to pipeline specifications, preferably in locations near the methanol micro-scale production unit; and/or (2) as fuel for any number of purposes, including vehicle propulsion, power generation, heating, and/or cooking.

In one preferred embodiment, a slipstream of natural gas is removed from a larger natural gas production facility to feed one or more micro-scale GTL units producing methanol. Such embodiments are particularly useful for gas production facilities in chemical product import remote locations. Depending upon the intended use of the methanol at or near the wellhead, the methanol may be low- or higher-grade methanol. For most near-wellhead applications, e.g. hydrate inhibition, low grade methanol is preferred. The product methanol may then be injected into the same gas production wells, gathering lines, and/or transmission pipelines for hydrate inhibition purposes.

In another preferred embodiment, particularly applicable to chemical product import remote locations, the micro-scale GTL units are employed in offshore gas or gas and oil production applications. More specifically, offshore production facilities use sub-sea pipelines that are subjected to cold temperatures, with temperature decreasing with increasing depths. Such conditions promote hydrate formation, which can lead to flow restrictions and/or plugging, in the sub-sea gas pipelines. Similarly, production facilities located in temperate and colder locations may also experience increased hydrate formation in exposed pipelines, especially during cold (winter) weather. Thus, methanol produced by the micro-scale GTL unit(s) may be injected into such sub-sea and/or exposed pipelines to prevent hydrate formation. These embodiment exemplify the combination of non-stranded (non-remote) gas resources with chemical product import remote locations.

Known processes illustrating the use of methanol and other chemicals for hydrate formation inhibition are discussed by Anderson and Prausnitz (AIChE Journal, 32(8), 1986, pp. 1321-1333) and Nielsen and Bucklin (Hydrocarbon Processing, 62(4), 1983, pp. 71-78), and are disclosed in U.S. Pat. Nos. 7,341,617; 7,323,609; 7,264,653; 7,253,138; 7,033,504; 7,008,466; 6,905,605; 6,867,262; 6,772,840; 6,581,687; 6,544,932; 6,451,892; 6,451,891; 6,436,877; 6,432,355; 6,397,948; 6,369,004; 6,359,047; 6,340,373; 6,331,508; 6,319,971; 6,298,724; 6,290,432; 6,281,274; 6,251,836; 6,242,518; 6,232,273; 6,222,083; 6,180,699; 6,173,780; 6,148,913; 6,117,929; 5,841,010; 5,741,758; 5,723,524; 5,690,174; 5,600,044; 5,583,273; 5,491,269; 5,331,105; 4,602,920; 4,597,779; 4,589,434, and 3,348,614, the disclosures of which are incorporated by reference in their entirety for all purposes.

In yet other embodiments of the invention, the micro-scale GTL-produced methanol may be used as a diluent for very heavy oil to improve the flow characteristics of such oil. Such embodiments are particularly useful for oil production facilities located in diluent remote locations. Likewise, micro-scale GTL-produced methanol may also be used to dilute waxy products of FT processes, including micro-scale FT GTL systems that may be located at a gas/oil production facility in a diluent remote and/or chemical remote location.

In some embodiments, finished gasoline, diesel, and/or substitute diesel (i.e., dimethyl ether) fuels, or fuel additives such as mixed higher alcohols or aromatics, may be produced either in individual micro-scale GTL units or, more preferably, “raw” micro-scale GTL products can be shipped (e.g., trucked) from a number of individual micro-scale GTL production units in a given geographical area to a larger (about 1,000 bbl/d or more) central processing facility for upgrading and/or conversion to fuel products. Such upgraded products may then be at least partially returned to the same or other, preferably nearby, oil and/or NG production facilities for local use.

In another preferred embodiment, particularly applicable to fuel product import remote locations, Fischer-Tropsch derived diesel fuel, methanol, dimethyl ether (which can be an effective diesel fuel substitute with adequate engine and fuel storage modifications), and/or mixed higher alcohols is employed in fueling the vehicles involved with the local oil and/or NG production facilities, especially fleets of service vehicles, personnel vehicles, equipment and/or liquid product movement and/or shipping vehicles or machinery. Methanol may be employed in internal combustion engines, either in pure form or blended with gasoline, as feed to produce H₂ for PEM fuel cells, or in direct methanol fuel cells. Dimethyl ether may also be used as a substitute for LPG applications. Even where the produced gas has an outlet (e.g., pipeline) by which the gas can be transported to markets, part of the produced gas may be converted to fuel products using a micro-GTL unit more economically than delivery of imported fuel products. For an on-shore facility, fuel products could be produced with a micro-GTL unit having the ability to upgrade syncrude. Alternatively, depending upon the number of resources located within an on-shore fuel product remote location, syncrude produced from micro-GTL units could be processed locally into fuel products at a central upgrading unit. For off-shore resources, fuel products would preferably be produced with one or more micro-GTL units having syncrude upgrading capability.

Essentially all natural gas derived liquid fuels, with the possible exceptions of those produced by halide and/or sulfur intermediated processes, have essentially zero nitrogen, sulfur, and metal contents, and thus produce little or no detrimental combustion byproducts. In addition, methanol, DME, and Fischer-Tropsch-derived diesel fuels have the added benefits of very low (or undetectable/zero) olefin and aromatic contents, as well as being at least partially biodegradable. Thus, the environmental impact of natural gas derived liquid fuels produced by these processes is much lower than for petroleum or coal derived fuels.

Mixed higher alcohols and/or hydrocarbons produced by micro-scale GTL units employing any number of other processes, such as direct oxidative or non-oxidative methane conversion or coupling, and processes based on bromine, chlorine, and/or sulfur processing are subject to the same considerations and constraints on production unit construction and portability, and capital and operating costs as previously discussed for FT and/or methanol synthesis derived products. Depending on the specific process employed, finished products may be produced directly in a micro-scale GTL unit or, alternatively, in larger, centralized facilities serving a number of micro-scale GTL units.

The micro-scale GTL units may be deployed in multiple, variable numbers to track gas production such as disclosed in U.S. patent application Ser. No. 12/129,401, filed on May 29, 2008, and entitled “Tracking Feedstock Production With Micro Scale Gas-to-Liquid Units,” the disclosure of which is incorporated herein by reference in its entirety. The micro-scale GTL units may employ portable start-ups units such as disclosed in U.S. patent application Ser. No. 12/104,161, filed on Apr. 16, 2008, and entitled “Micro Scale Fischer-Tropsch and Oxygenate Synthesis Process Startup Unit.” Moreover, when based on synthesis gas production and FT and/or oxygenate synthesis, the micro-scale GTL units may include portable activation/regeneration units and/or hydrogenative pre-reformers such as disclosed in U.S. patent application Ser. No. 12/040,500, filed on Feb. 29, 2008, and entitled “Fischer-Tropsch and Oxygenate Synthesis Catalyst Activation/Regeneration in a Micro Scale Process,” and U.S. patent application Ser. No. 12/061,355, filed on Apr. 2, 2008, and entitled “Hydrogenating Pre-Reformer In Synthesis Gas Production Processes”, the disclosures of which is incorporated herein by reference in its entirety.

We claim:

1. A method of operating one or more production facilities located at a remote NG source, the method comprising:
providing one or more micro-scale GTL systems to the remote NG source;
supplying NG feedstock from the remote NG source to the one or more micro-scale GTL systems;
operating the one or more micro-scale GTL systems to produce a product stream; and
utilizing the product stream in the one or more production facilities located at the remote NG source.

2. The method of claim 1, wherein the NG feedstock is a slipstream from an oil and/or natural gas wellhead.

3. The method of claim 2 wherein the product stream comprises methanol.

4. The method of claim 3 wherein the remote NG source is located at a chemical product import remote location.

5. The method of claim 4 wherein the methanol contains at least about 10% water.

6. The method of claim 5 further comprising inhibiting hydrate formation within the one or more production facilities by injecting the methanol into the wellhead, one or more gathering lines, one or more transmission pipelines, or one or more sub-sea gas pipelines.

7. The method of claim 5 further comprising dehydrating a low quality natural gas stream by utilizing the methanol product in a natural gas dehydration process.

8. The method of claim 5 further comprising removing acid gas from a low quality natural gas stream by utilizing the methanol product in an acid gas removal process.

9. The method of claim 3 further comprising shipping the methanol product stream to a non-remote location; and purifying the methanol product stream to a chemical grade methanol product at the non-remote location.

10. The method of claim 3 wherein the utilizing the product stream in the one or more production facilities located at the remote NG source comprises diluting a heavy hydrocarbon stream by injecting the methanol into the heavy hydrocarbon stream.

11. The method of claim 10 wherein the heavy hydrocarbon stream is selected from the group of a waxy Fischer-Tropsch product, heavy oil produced from the one or more production facilities, and combinations thereof.

12. The method of claim 4 wherein the remote NG source is located at a fuel product import remote location.

13. The method of claim 12 wherein the product stream includes methanol and wherein the step of utilizing the product stream comprises utilizing the methanol as an internal combustion engine fuel.

14. The method of claim 12 wherein the methanol is used either in substantially pure form or blended with conventional or synthetic gasoline prior to the utilizing as an internal combustion fuel.

15. The method of claim 3 wherein the step of utilizing the product stream comprises utilizing the methanol as a feedstock for production of hydrogen to generate electrical power with a proton exchange membrane (PEM) fuel cell, to generate electrical power in a direct methanol fuel cell, or a combination thereof.

16. The method of claim 4 wherein the step of utilizing the product stream comprises utilizing the methanol as a freeze-point depressant.

17. The method of claim 12 further comprises the step of converting the methanol to a fuel product stream comprising synthetic gasoline.

18. The method of claim 1 wherein the product stream comprises dimethyl ether.

19. The method of claim 16 wherein the step of utilizing the product stream comprises utilizing the dimethyl ether as a substitute diesel fuel, an LPG fuel substitute, or a combination thereof.

20. The method of claim 18 further comprising the step of converting the dimethyl ether to a fuel product stream comprising synthetic gasoline.

21. The method of claim 3 wherein the product stream includes mixed higher alcohols and wherein the step of utilizing the product stream comprises utilizing the mixed higher alcohols in substantially pure form or blended with conventional or synthetic gasoline as an internal combustion fuel.

22. The method of claim 1 wherein the product stream is a Fischer-Tropsch derived hydrocarbon liquid.

23. A method of operating one or more production facilities located at a remote NG source, the method comprising:
providing one or more micro-scale GTL systems;
supplying NG feedstock from the remote NG source to the one or more micro-scale GTL systems;
operating the one or more micro-scale GTL systems to produce a product stream; and
supplying the product stream to a central processing unit within the remote location to produce a fuel product.

24. The method of claim 23, wherein the product stream is synthetic crude oil

25. The method of claim 24 wherein the product stream comprises synthetic crude oil and wherein the synthetic crude oil is produced in a Fischer-Tropsch process.

26. The method of claim 23, further comprising utilizing the fuel product as a fuel at the one or more production facilities.

27. The method of claim 23 wherein the fuel product comprises synthetic diesel fuel.

28. A method of operating one or more production facilities located at a remote NG source, the method comprising:
providing one or more micro-scale GTL systems;
supplying NG feedstock from the remote NG source to the one or more micro-scale GTL systems;
operating the one or more micro-scale GTL systems to produce a product stream;
wherein at least part of the product stream comprises a light distillate, naphtha stream, or combination thereof; and
utilizing the product stream in the one or more production facilities located at the remote NG source.

29. The method of claim 28 wherein the step of utilizing the product stream comprises diluting a heavy hydrocarbon stream.

30. The method of claim 29 wherein the heavy hydrocarbon stream is selected from the group of a waxy Fischer-Tropsch product, heavy oil produced from the one or more production facilities, and combinations thereof.

31. The method of claim 29 wherein the heavy hydrocarbon stream comprises bitumen produced from oil or tar sands, bitumen derived products produced from oil or tar sands, or combinations thereof.

32. The method of claim 1 wherein the one or more micro-scale GTL systems are sized to fit within normal truck bed shipping size constraints and have a total weight of less than about 20 tons.

33. The method of claim 23 wherein the one or more micro-scale GTL systems are sized to fit within normal truck bed shipping size constraints and have a total weight of less than about 20 tons.

34. The method of claim 28 wherein the one or more micro-scale GTL systems are sized to fit within normal truck bed shipping size constraints and have a total weight of less than about 20 tons.
